(19) United States
(12) Patent Application Publication
(10) Pub. No.: US 2012/0125193 A1
(43) Pub. Date: May 24, 2012

(54) PRESSURE TRANSFER MEANS AND PRESSURE MEASURING TRANSDUCER WITH A PRESSURE TRANSFER MEANS

(75) Inventor: Michael PHILIPPS, Lorrach (DE)

(73) Assignee: Endress + Hauser GmbH + Co. KG, Maulburg (DE)

(21) Appl. No.: 13/300,744

(22) Filed: Nov. 21, 2011

(30) Foreign Application Priority Data
Nov. 24, 2010 (DE) 10 2010 061 898.5

(51) Int. Cl. F01B 19/00; B23P 17/00; F01B 31/12

(52) U.S. Cl. 92/5 R; 92/97; 29/890.09

(57) ABSTRACT

A pressure transfer device comprises a hydraulic path, which is formed by a duct, which extends through a solid body arrangement from a pressure source to a pressure sink, wherein the pressure source comprises a separating diaphragm chamber, which communicates with the duct, and which is sealed with a flexible isolating diaphragm, wherein the isolating diaphragm is contactable with a pressure to be transferred, wherein the pressure sink comprises a sealed sink chamber, which communicates with the duct, wherein the separating diaphragm chamber, the duct and the pressure sink chamber are filled with a pressure transfer liquid, wherein the pressure transfer liquid has according to the invention a magnetically changeable viscosity, and wherein the pressure transfer means further comprises in at least one section of the hydraulic path at least one magnet for influencing the viscosity of the pressure transfer liquid.

The present invention relates to a hydraulic pressure transfer means and a pressure measuring transducer with a pressure transfer means.

Pressure transfer means comprise a hydraulic path, which is formed by a duct, which extends through a solid body arrangement from a pressure source to a pressure sink and which is filled with a pressure transfer liquid. The pressure source comprises, usually, a separating membrane, or diaphragm, chamber, which communicates with the duct, and which is sealed relative to the environment with a flexible, isolating diaphragm, wherein the isolating diaphragm is contactable with a pressure to be transferred. The pressure sink comprises, usually, a pressure sensor, which is arranged in a sensor chamber, which communicates with the duct.

The transfer characteristic of the hydraulic path depends on the viscosity of the transfer liquid. By selecting suitable fill liquids with high viscosity, for example, in combination with constrictions of the duct cross section or the use of porous bodies in the duct, damping elements can be implemented, in order, for example, to damp overload shocks. Highly viscous transfer liquids can, however, be filled only very slowly into the hydraulic path.

In order to handle this, Offenlegungsschrift DE 102004033813 A1 discloses pressure transfer means with thixotropic fill liquids, which, in the case of sufficient flow velocity, thus, for instance, in the case of filling, are distinguished by low viscosity, and which, in measurement operation, in the case of which the liquid is practically not moving, become very viscous again.

The available thixotropic liquids are, however, not suitable for all cases of application and process media, since, on the one hand, the thixotropic properties depend on temperature, and, on the other hand, thixotropic fill liquids are not acceptable for certain kinds of processes.

It is, consequently, an object of the invention to provide a pressure transfer means and a therewith equipped, pressure measuring transducer, which overcome the disadvantages of the prior art.

The object is achieved according to the invention by a pressure transfer means as defined in independent claim 1, a pressure measuring transducer as defined in independent claim 6 and a method for manufacture of a pressure transfer means as defined in independent claim 10.

The pressure transfer means of the invention comprises:

A hydraulic path, which is formed by a duct, which extends through a solid body arrangement from a pressure source to a pressure sink,

wherein the pressure source comprises a separating diaphragm chamber, which communicates with the duct, and which is sealed with a flexible isolating diaphragm, wherein the isolating diaphragm is contactable with a pressure to be transferred,

wherein the pressure sink comprises a sealed sink chamber, which communicates with the duct,

wherein the separating diaphragm chamber, the duct and the pressure sink chamber are filled with a pressure transfer liquid,

wherein the pressure transfer liquid has according to the invention a magnetically changeable viscosity, and wherein the pressure transfer means further comprises in at least one section of the hydraulic path at least one magnet for influencing the viscosity of the pressure transfer liquid.

The sink chamber can have, for example, a sensor chamber, which is sealed by a deformation body of a pressure sensor, or a second separating diaphragm chamber, which is sealed by a second flexible isolating diaphragm.

In a currently preferred, further development of the invention, the at least one magnet comprises at least one permanent magnet, whose field acts on the fill liquid in a section of the hydraulic path, in order to influence the viscosity of the fill liquid.

In a further development of the invention, the at least one permanent magnet comprises a magnet body, which is arranged outside of the duct, and its magnetic field passes at least sectionally through the lumen of the duct.

In another further development of the invention, the at least one permanent magnet comprises a ferromagnetic body, through which extends at least one section of the duct. Especially, the ferromagnetic body can have a capillary tube for this.

In this connection, for example, a wall section of the capillary line can comprise a ferromagnetic material; or a ferromagnetic filling, element, through which extends a passageway for the pressure transfer liquid, can be inserted into a bore coaxial with the passageway in a solid body, through which the duct extends. The solid body can comprise, for example, a stainless steel.

Fundamentally, the at least one permanent magnet can also comprise a filling element, which is inserted into the duct, and which has no passageway for the pressure transfer liquid. The filling element has preferably a length in the transfer direction of the duct that is greater than the square root of the average cross sectional area of the duct, wherein the length amounts, for example, to more than 2-times, especially more than 4-times, the square root of the average cross sectional area of the duct at the site of the filler body

In another further development of the invention, the at least one permanent magnet comprises a large number of magnetized ferromagnetic particles, which are contained in the fill liquid.

In another further development of the invention, the at least one magnet comprises at least one electromagnet, whose magnetic field passes at least sectionally through the lumen of the duct.

In another further development of the invention, the fill liquid comprises a suspension of magnetic and/or magnetizable particles.

The magnetic or magnetizable particles can be, for example, ferromagnetic or paramagnetic particles.

In a further development of the invention, the particles comprise iron or magnetite.

In another further development of the invention, the magnetic and/or magnetizable particles have an electrically non-conductive surface, for example, in the form of a coating.

The pressure measuring transducer of the invention comprises a pressure transfer means of the invention and a pressure sensor, which has a deformation body, which is contactable with pressure introduced via the hydraulic path into the pressure sink chamber, wherein the pressure sensor comprises a transducer to transduce a pressure-dependent deformation of the deformation body into an optical or electrical signal.

The method of the invention for the manufacture of a pressure transfer means comprises:

Providing a solid body arrangement having a hydraulic path, which comprises a separating diaphragm chamber, a duct and a pressure sink chamber, wherein the duct extends from the separating diaphragm chamber to the pressure sink chamber; and filling the hydraulic path with a pressure transfer liquid, which has a magnetically changeable viscosity; wherein the fill liquid, at least after the filling, at least in a section of the hydraulic path, is magnetized or is exposed to a magnetic field by means of a magnet.

The magnetizing with electromagnets enables, additionally, a variable magnetizing and, associated therewith, a variable adjusting of the viscosity of the pressure transfer liquid.

A pressure measuring transducer or pressure transfer means with a magnetically rheological, pressure transfer liquid, thus a pressure transfer liquid with a magnetic field dependent viscosity, enables, additionally, a diagnosis of the pressure transfer. For example, the pressure lines in the case of flow measurement using the pressure difference principle can plug, which is accompanied by a steady increase of the damping of the (difference-)pressure signal. On the one hand, the pressure signal, or pressure difference signal, can be subjected to a frequency analysis, in order to detect the increasing plugging. This is known, but requires a certain analytical effort.

The pressure transfer means, or pressure measuring transducer, of the invention enables, in the case of embodiments with variable viscosity adjustment, experimentally to ascertain which changes of viscosity have an effect on the spectrum or selected frequencies of the pressure, or pressure difference, signal. In this way, the degree of plugging of the pressure difference lines in the flow measurement can be determined.

For implementing a damping (as discussed above in detail) with a constant magnetic field, the viscosity of the pressure transfer liquid can be increased.

On the other hand, according to a further development of the invention, with a magnetic alternating field, the viscosity of the pressure transfer liquid can be reduced, be it through immediate agitation due to the alternating field or through a local warming following therefrom. A pressure transfer liquid with decreased viscosity is suitable to flow through capillary lines of small cross section and rapidly to fill a chamber with flow obstructions. Thus, the applying of an alternating field through connection of an electromagnet can be advantageous in the filling of the pressure transfer means.

Finally, there is still to be mentioned an advantageous feature of the invention, which favors the high temperature stability of the pressure transfer means of the invention. Through the magnetic ordering of the fill liquid in the constant magnetic field via the magnetic or magnetized particles and, in given cases, via the orientation of magnetic moments of the molecules matrix of the liquid, the effective heat of evaporation of the molecules is increased, which leads to a sinking of the vapor pressure.

The invention will now be explained based on the examples of embodiments illustrated in the drawing, the figures of which show as follows:

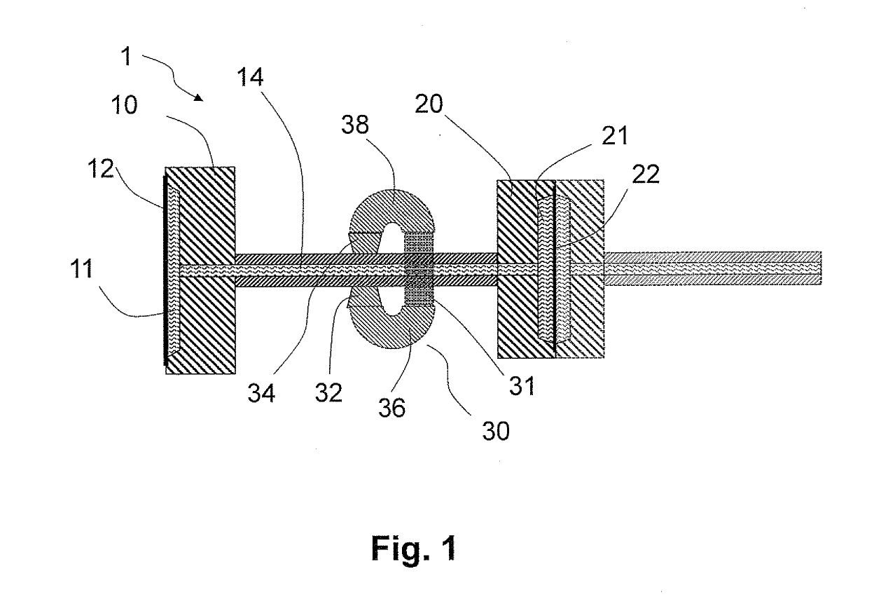

FIG. 1 a longitudinal section through a first example of an embodiment of a pressure transfer means of the invention;

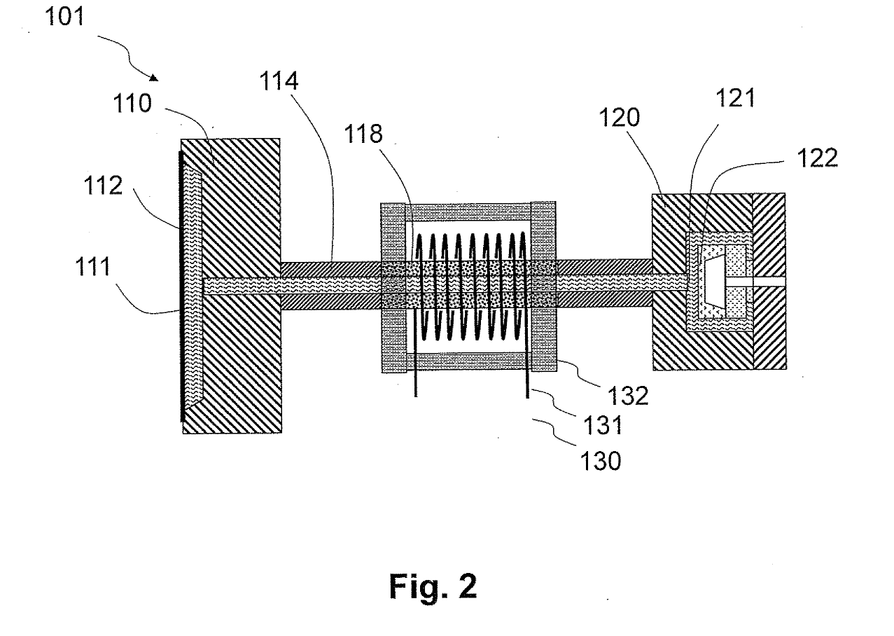

FIG. 2 a longitudinal section through a first example of an embodiment of a pressure measuring transducer of the invention; and

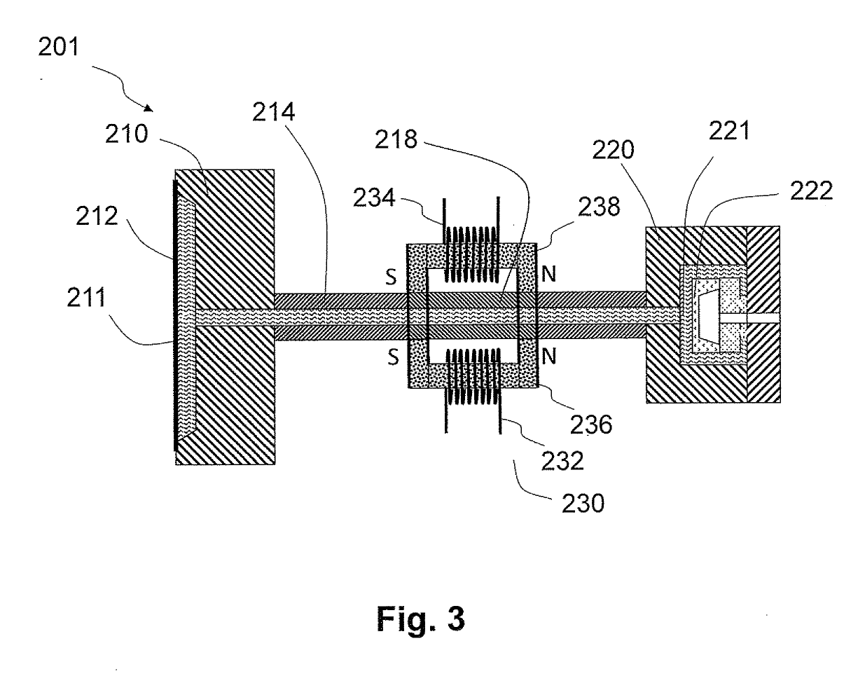

FIG. 3 a longitudinal section through a second example of an embodiment of a pressure measuring transducer of the invention.

The pressure transfer means 1 shown in FIG. 1 comprises a first, essentially cylindrical, separating diaphragm support 10, on whose end a first separating diaphragm chamber 11 is formed by connecting with the end a first isolating diaphragm 12 along, an encircling weld seam.

The separating diaphragm chamber communicates via a duct 14 (which is formed by a capillary line) with a second, essentially cylindrical, separating diaphragm support 20, on whose end face a second separating diaphragm chamber 21 is formed by connecting a second isolating diaphragm 22 with the end face along an encircling weld seam. The first isolating diaphragm 12 is contactable with a media pressure to be transferred. The media pressure is introduced through the first isolating diaphragm into the first separating diaphragm chamber 11, from where it is transferred by means of a pressure transfer liquid to the second separating diaphragm chamber 21, and can be felt on the second isolating diaphragm 22.

The transfer liquid has a magnetically changeable viscosity. For this, the pressure transfer liquid can contain, for example, a suspension of magnetic or magnetizable particles, which, to the extent that they are electrically conductive, in given cases, can be coated with an electrical insulator, in order to prevent electrical short circuits through the particles. This is, however, required for pressure transfer means only to the degree that the hydraulic path is bordered by surface sections, or surrounded by surface sections, which lie at different electrical potentials. In the case of most pressure transfer means applications, this is not the case.

The pressure transfer liquid is preferably filled without the presence of the magnetic field in the hydraulic path. This enables that the liquid can easily flow through narrow flow cross sections of the hydraulic path in a state of low viscosity and can reliably fill the entire volume of the hydraulic path.

By establishing an at least local ordering by means of a magnetic field, the viscosity of the fill liquid can be increased, whereby an effective damping against overload shocks is formed.

In the example of an embodiment shown here, for this, a magnetizing arrangement 30 is used, which comprises a permanent magnet 31, whose field is impressed on the duct perpendicularly to the longitudinal axis of the duct 14 by means of pole shoes 32, 34, and yokes 36, 38, in order to achieve an orienting of the metal particles, whereby the effective viscosity of the pressure transfer liquid in the region of the magnetic field significantly rises.

Of course, with a permanent magnet and a yoke for field guidance, there can be impressed on the duct also a magnetic field, which extends parallel to the duct.

The pressure measuring transducer 101 shown in FIG. 2 comprises an essentially cylindrical, separating diaphragm support 110, on whose end a separating diaphragm chamber 111 is formed by connecting an isolating diaphragm 112 with the end along an encircling weld seam.

The separating diaphragm chamber communicates via a duct 114 (which is formed by a capillary line) with a second, essentially cylindrical, sensor chamber body 120, in whose interior a sensor chamber 121 is formed, which contains a semiconductor pressure sensor 122. A measuring diaphragm of the semiconductor pressure sensor 122 is contactable on its front side, which faces the hydraulic path formed by the duct and the first isolating diaphragm, by means of a pressure transfer liquid, with which the hydraulic path is filled, with a media pressure present on the first isolating diaphragm 112, while the rear side of the measuring diaphragm is contactable with atmospheric pressure.

The pressure transfer liquid has a magnetically changeable viscosity. For this, the pressure transfer liquid can contain, for example, a suspension of metal particles, which are coated with an electrical insulator, in order to prevent electrical short circuits through the metal particles. The coatings can comprise, for example, glass, ceramic or synthetic materials, such as plastics.

The filling of the hydraulic path occurs in the low viscosity state of the pressure transfer liquid, thus without the presence of an electrical field.

The pressure measuring transducer 101 further comprises a magnet arrangement 130, which, in this example of an embodiment, is an electromagnet, which is formed by a coil 131 and a yoke 132, wherein the coil axis and the axis of the yoke essentially align with the axis of the duct 114. The duct 114 can comprise, in a section 118, which is surrounded by the magnet arrangement, deviating from the usually used stainless steel, on the one hand, a ferromagnetic material with large remanence and/or coercive force, or, on the other hand, glass.

The variant with the ferromagnetic material enables a permanent magnetizing of the duct section, so that the increased viscosity due to magnetizing also remains without flow of the coil current. This is advantageous in the case of limited availability of electrical energy. For purposes of lessening the magnetizing, for example, in the sense of an improved transfer dynamic or for diagnostic purposes, a field counter to the magnetization can be applied, when required.

To the extent that the duct section 118 is a non-magnetic material, such as glass, the magnetic field of the coil 131 acts directly on the metal particles in the suspension, which, thus, form the core of the coil. In the case of sufficiently magnetizable particles, also occasional applying of a field can provide a certain degree of order and therewith an increased viscosity. Depending on what the use conditions of the pressure measuring transducer are as regards temperature and vibrations, the time span can vary until a renewed magnetizing is required. In given cases, it can be necessary to apply the external magnetic field permanently.

FIG. 3 shows a pressure measuring transducer according to an additional example of an embodiment of the invention, wherein here a section of the hydraulic path has a permanent magnet. The pressure measuring transducer 201 comprises an, essentially cylindrical, separating diaphragm support 210, on whose end a separating diaphragm chamber 211 is formed by connecting an isolating diaphragm 212 with the end along an encircling weld seam.

The separating diaphragm chamber communicates via a duct 214 (which is formed by a capillary line) with a second, essentially cylindrical, sensor chamber body 220, in whose interior a sensor chamber 221 is formed, which contains a semiconductor pressure sensor 222. A measuring diaphragm of the semiconductor pressure sensor 222 is contactable on its front side, which faces the hydraulic path formed by the duct and the first isolating diaphragm, by means of a pressure transfer liquid, with which the hydraulic path is filled, with a media pressure present on the first isolating diaphragm 212, while the rear side of the measuring diaphragm is contactable with atmospheric pressure.

The pressure transfer liquid has a magnetically changeable viscosity. For this, the pressure transfer liquid can contain, for example, a suspension of metal particles, which are coated with an electrical insulator, in order to prevent electrical short circuits through the metal particles. The coatings can comprise, for example, glass, ceramic or synthetic materials, such as plastics.

The filling of the hydraulic path occurs in the low viscosity state of the pressure transfer liquid, thus without presence of an electrical field.

The pressure measuring transducer 201 comprises a permanently magnetized, ferromagnetic section 218 of the capillary line of the duct 214, in which the pressure transfer liquid has, due to the local ordering, an increased viscosity.

For magnetizing the section 218 of the capillary line after the filling, temporarily, a magnet arrangement 230 is arranged around the section 218. Magnet arrangement 230 includes, for example, two half shells having, respectively, a coil 232, 234 and a yoke 236, 238. After magnetizing the duct section 218, the magnet arrangement 230 is removed.

All examples of embodiments serve only to illustrate the invention and are variable as much as desired as regards location of the magnetizing, the spatial expanse of the magnetized region, the orientation the magnetic field (with reference to the duct, axial or transverse) and the type of magnetizing source (external, permanent magnet, duct as permanent magnet, or coil arrangement).

Examples of suitable pressure transfer liquids are given in Offenlegungsschrifts DE 39 04 757 A1 and EP 0 328 498 A2 as well as in the patent documents DE 69 321 247 T2 and DE 101 93 378 T5, as well as in the references cited therein. An overview of suitable pressure transfer liquids is given in the article, “Experiments with Magnetic Liquids”, by Mahr and Rehberg, which was published on Jan. 8, 1997, as an Elsevier preprint.

1-13. (canceled)

14. A pressure transfer means, comprising: a hydraulic path, which is formed by a duct, which extends through a solid body arrangement from a pressure source to a pressure sink;
a flexible isolating diaphragm;
a second flexible isolating diaphragm;
at least one magnet;
a separating diaphragm chamber comprising a pressure source, which communicates with said duct, and which is sealed with said flexible isolating diaphragm, said isolating diaphragm being contactable with a pressure to be transferred; and
a pressure sink which comprises a sealed sink chamber, which communicates with said duct, wherein:
said separating diaphragm chamber, said duct and said pressure sink chamber are filled with a pressure transfer liquid;
the pressure transfer liquid has a magnetically changeable viscosity;
said at least magnet located in at least one section of the hydraulic path for influencing the viscosity of the pressure transfer liquid; and
said sink chamber can have, a sensor chamber, which is sealed by a deformation body of a pressure sensor, or a second separating diaphragm chamber, which is sealed by said second flexible isolating diaphragm.

15. The pressure transfer device as claimed in claim 14, wherein:
said at least one magnet comprises at least one permanent magnet, whose field acts on the fill liquid in a section of said hydraulic path, in order to influence the viscosity of the fill liquid.

16. The pressure transfer device as claimed in claim 14, wherein:
said at least one permanent magnet comprises a magnet body, which is arranged outside of said duct, and whose magnetic field passes at least sectionally through the lumen of said duct.

17. The pressure transfer device as claimed in claim 14, wherein:
said at least one permanent magnet comprises a ferromagnetic body, through which extends at least one section of said duct; and
said ferromagnetic body comprises, especially, a capillary tube.

18. The pressure transfer device as claimed in claim 14, wherein:
said at least one permanent magnet comprises a filling element, which is arranged in said duct.

19. The pressure transfer device as claimed in claim 18, wherein:
said filling element has a passageway for the fill liquid.

20. The pressure transfer device as claimed in claim 4, wherein:
said at least one permanent magnet comprises a large number of magnetized, ferromagnetic particles, which are contained in the fill liquid.

21. The pressure transfer device as claimed in claim 14, wherein:
said at least one magnet comprises at least one electromagnet, whose magnetic field passes at least sectionally through the lumen of said duct.

22. The pressure transfer device as claimed in claim 14, wherein:
the fill liquid comprises a suspension of magnetic and/or magnetizable particles.

23. The pressure transfer device as claimed in claim 22, wherein:
the magnetic and/or magnetizable particles have an electrically non-conductive surface, for example, in the form of a coating.

24. A pressure measuring transducer, comprising:
a pressure transfer device as claimed in claim 14 and;
a pressure sensor, which has a deformation body, which is contactable with a pressure introduced into the pressure sink chamber via the hydraulic path, wherein:
said pressure sensor comprises a transducer to transduce a pressure-dependent deformation of the deformation body into an optical or electrical signal.

25. A method for manufacture of a pressure transfer device,
comprising the steps of:
providing a solid body arrangement having a hydraulic path, which comprises a separating diaphragm chamber, a duct and a pressure sink chamber, wherein the duct extends from the separating diaphragm chamber to the pressure sink chamber; filling the hydraulic path with a pressure transfer liquid, which has a magnetically changeable viscosity; and
magnetizing the pressure transfer liquid, at least after the filling, at least in a section of the hydraulic path, with a constant magnetic field or is exposed by means of a magnet to a constant magnetic field.

26. The method as claimed in claim 25, wherein:
in the filling, a magnetic alternating field is applied, in order to reduce the viscosity of the pressure transfer liquid, at least in the region of the alternating field.
